(19) United States
(12) Patent Application Publication
(10) Pub. No.: US 2026/0307339 A1
(43) Pub. Date: Oct. 8, 2026

(54) FABRIC AND RESIN COMPOSITE MATERIAL PART

(71) Applicant: SAFRAN AIRCRAFT ENGINES, PARIS (FR)

(72) Inventors: Lucas Antoine Christophe LAUWICK, MOISSY-CRAMAYEL (FR); Antoine DAREYS, MOISSY-CRAMAYEL (FR); Celia IGLESIAS CANO, MOISSY-CRAMAYEL (FR)

(21) Appl. No.: 19/108,205

(22) PCT Filed: Aug. 29, 2023
(86) PCT No.: PCT/FR2023/051310

§ 371 Date: Mar. 3, 2025

(30) Foreign Application Priority Data
Sep. 2, 2022 (FR) FR2208853

(51) Int. Cl. B29C 70/24; B29C 45/44; B29L 31/08

(52) U.S. Cl. CPC B29C 70/24; B29C 45/4457; B29L 2031/085; B29L 2031/087

(57) ABSTRACT

A three-dimensionally molded part includes a composite material including a fibrous preform and a resin, the part having a cavity filled with a cellular material. The cellular material includes an expanded cellular polymeric material. A method of manufacturing the molded part includes weaving the part to include a cavity and placing a soluble core, a removable demoldable core or a flexible membrane in the cavity before subsequent processing steps.

### TECHNICAL FIELD

The present invention relates to the field of aircraft parts, such as propeller blades or vanes, which may be present in turboprops or aeronautical turbine engines, including those with unducted propellers. Casings of aeronautical turbine engines are also particularly targeted.

Hereinafter, the term “blade” covers both fixed vanes and aeronautical propeller blades.

Often, such aircraft parts are made of metal. Although they then have good mechanical strength, they nevertheless pose the problem of a relatively high mass.

In order to obtain lighter parts, it is known to produce them by using composite material, i.e. such as structural parts with fiber reinforcement and a resin matrix.

### PRIOR ART

EP3511240 thus presents a solution for a fibrous structure for reinforcing an aeronautical vane (or propeller blade) made of composite material. This structure is woven as a single piece, integrating an airfoil, a spar portion, and a bulged portion. The fibrous structure comprises a decoupling zone which makes it possible to form a housing inside the fibrous structure into which is inserted part of a reinforcement insert, which here is a spar of which a portion therefore extends into the interior of the airfoil, at the decoupling zone(s), and another portion leads to outside the airfoil at the root edge of the airfoil. The bulged portion extends as an extension of the spar portion outside the airfoil. The airfoil comprises skins, at the decoupling zone(s), which are decoupled relative to each other and which clasp the spar portion. The skins respectively delimit, at the airfoil, two housings which are present one to either side of the spar portion and which have their openings at the root edge of the airfoil. The final blade is a piece having a cavity into which inserts, made of a traditional rigid foam in solid form, have been introduced.

In the field of aeronautical turbine engines with shrouded blades or propellers, numerous turbine engines are also known through which multiple gas flows travel, in particular having a primary flow and secondary flow, or dual flow.

### TECHNICAL PROBLEM

For several years, at least in aeronautical dual-flow turbine engines, increasing the bypass ratio (ratio between the flow rate of the primary flow and the secondary flow) has been a solution favored by engine manufacturers to improve engine performance and reduce their specific fuel consumption.

This results in an increase in the diameter of the iso-thrust blade assemblies of the turbine engines, in particular concerning the first blade assembly, where air enters the turbine engine: fan blade or propeller, and the associated rectifier (OGV or Outlet Guide Vane).

This increase is even more significant for unducted architectures.

However, the increase in these dimensions has the disadvantage of resulting in an increase in the mass of the blades and/or casings, which is detrimental to the performance of a turbine engine.

Until now, one solution for limiting this impact on the mass has been to manufacture the blades and/or casings in solid composite materials (3D woven composite material via the RTM process for example—Resin Transfer Molding or resin injection molding, instead of metal materials (for example titanium).

However, given the predictable dimensions of future blades, for example in an unducted architecture of an aeronautical turbine engine of the ‘Open FAN’, ‘Unducted Single FAN’ or ‘Propfan’ type, it seems necessary to be able to increase this reduction in mass.

One of the possible solutions to overcome this problem is to design and/or produce hollow aeronautical parts (referred to as hollow parts).

However, during operation of an aeronautical turbine engine, and if hollow parts are used, in particular blades, these are subjected to significant pressure from the air flow moved along by the turbine engine to provide thrust. This pressure can deform the part where it is hollowed out, by crushing the cavity in the part, and thus, for example in a fan blade, could significantly reduce its efficiency, due to the deformation of the airfoil sections of the part.

A cellular material such as high-density foam may be used to fill the cavity, which makes it possible to meet the need for lightening and improving the mechanical properties of the part as well as limiting or even completely suppressing the crushing of the skins.

However, during operation of the turbine engine, the parts (in particular the blades or vanes) work mechanically, in particular or primarily with bending stresses under the influence of the air flow. To limit the impact of these forces, it is known-as in EP3511240 to add one or more inserts to form a stiffener. In the case where the stiffener is or includes a spar, and the composite part is a blade, the spar may also be used as a point of attachment of the blade on the disc of the turbine engine and thus makes it possible to create a link between the aerodynamic skins of the blade, the cellular material in the cavity, and the rest of the turbine engine.

The production of hollow parts composed of numerous sub-components is always difficult, because manipulating them before they are consolidated by a resin is tricky. The assembly of the various sub-components must be very precise and repeatable so that the parts are compliant without a high rate of rejects in manufacturing.

Supplying a part made of traditional rigid foam, in solid form and with precise geometric dimensions, also represents a significant logistical and financial effort for a filling insert having weak or even negligible mechanical properties concerning the general behavior of the finished part.

Any stiffeners, which may therefore be spars, are moreover generally designed as separate parts, subject to the same disadvantages as rigid foam (sensitivity during assembly, logistical complexity, etc.).

There is a need to improve the compactness of such a part and to reduce its mass, the number of weave layers, and the manufacturing cost.

### DESCRIPTION OF THE INVENTION

In view of the prior art, the present application proposes both a composite (molded) part and a method for manufacturing a composite part.

More specifically, the present invention relates in particular to a part (which may be three-dimensional) comprising a composite material including a fabric and a resin, the part having at least one cavity filled with a cellular material (also called alveolar); hereinafter, this cellular material comprises an expanded cellular polymeric material which is a foam (from a) polymer. The fabric is formed by three-dimensional weaving. The part may have one cavity or several cavities.

Each cavity has a bottom and at least one opening, in particular one opening. The positioning of the at least one opening is adapted to improve the mechanical properties of the part and/or to facilitate introducing the expanded cellular polymeric material at the bottom of the cavity. The at least one opening is for example positioned opposite to the bottom of the cavity.

The term “fabric” means a surface obtained by assembling threads or fibers that can be arranged in two series of intersecting paths. The term therefore encompasses a fibrous preform or woven preform. It may be any woven or non-woven material, a woven or non-woven cloth, and therefore an actual fabric.

The “fabric” or the fibrous structure, and therefore the part resulting from it, may be formed using any type of weaving: two-dimensional (2D), three-dimensional (3D), in particular.

By “two-dimensional weaving” or “2D weaving”, we mean a conventional weaving method by which each warp thread passes from one side to the other of the threads of a single weft layer.

By “three-dimensional weaving” or “3D weaving”, we mean a weaving method by which at least some of the warp threads entwine with weft threads in several weft layers.

The term “part” covers any type of part. It may be an unfinished part, such as a semi-finished part. It may be a preform: the preform of a finished part.

The term “foam”, as used in the terms expansive or expanded foam, has the following meaning: the medium resulting from the expansion of an expandable paste capable of expanding to form a foam (solid continuous phase in which a gaseous phase is dispersed in the form of cells). The emulsion and the creation of the gaseous phase generating the foam result from the expansion reaction of a paste that previously existed in the liquid phase. Thus, unlike a traditional foam supplied in solid form (hereinafter referred to as solid foam) and therefore having its own shape before its use in the production process, the present “foam from an expanded polymer” will be supplied in liquid form (the polymer paste) but becomes solid during the expansion reaction and does not have its actual shape until it has solidified and expanded in the cavity of the part.

“Solid foam” means: a rigid foam machined directly to the final shape, such as the products used in the State of the Art. In contrast, the expansive foam used here makes it possible to “make up for” any deviations relative to the geometric tolerances.

Among the advantages, one will note a simplification of the manufacturing process. Other advantages are noted below.

In the part, the expanded cellular polymeric material may in particular be polyurethane. Advantage: widely used material, well understood, inexpensive, very effective for filling in a volume/space.

Advantageously, the cavity is delimited by the composite material. More precisely, a wall of the composite material delimits the cavity.

Advantageously, the part comprises at least one insert, in particular woven, for example woven in three dimensions. The insert may be adapted to define a stiffener (also defined below as a possible spar). The insert is in particular arranged in one of the at least one cavities of the part.

Now, in terms of a method for manufacturing a part (which may be as above) comprising a weave, the method of the invention provides at least a partial answer to the problem stated above and thus presents these steps (which may possibly be nested, i.e. carried out at least partially together):
weaving the part while integrating therein at least one cavity, for example one cavity or several cavities, each cavity having a bottom and at least one opening,
placing the part in a first portion of an injection mold,
placing a soluble core or a removable demoldable core or a flexible membrane in the cavity, the soluble core or the membrane (including its internal space) occupying the volume of said cavity,
closing the injection mold, by means of at least a second portion of the injection mold,
injecting resin into the weave of the part, in order to form a woven part made of composite material,
demolding the part from the injection mold,
depending on the case, dissolving the soluble core, or removing the removable core or flexible membrane from the cavity,
placing in the cavity an expansive paste adapted to form a cellular material,
waiting for the paste to react to form (preferably completely) said cellular material in the cavity,
removing any excess cellular material that has overflowed from the cavity, if there is such.

The wait will be for a time (tmin) of more than one second. The wait will depend on the precise references of the expansive product used, the manufacturer's recommendations, and production experience which allows adapting to the geometry and volume to be filled. Generally, the time varies from a few seconds to less than 5 minutes.

The removing of any excess cellular material may include or consist of a final machining of the part, which allows obtaining a finished part (with the exact desired shape) or a semi-finished part (for example, there may be a need to install certain reinforcements or to apply a surface treatment). It may also involve deburring, checking that the part is in compliance (verifying the composite material, verifying the dimensions). All of this can thus be defined as finishing the part. If a possible surplus is to be removed, the cavity is then already rigid. The foam only needs to fill the cavity. Thus, if removing the excess expanded foam is to take place, in principle it will be advantageous to wait for the reaction to end so as not to have to eliminate this excess multiple times.

Thus, after waiting for the paste to react, which allows it to become (preferably completely) said cellular material, it will be possible and useful to:
remove the excess expanded material overflowing from the cavity, if there is such, and
check that the part is in compliance (verify the composite material, verify the dimensions, etc.), then
finalize the finishing of the part.

In the above method, the cellular material will usefully comprise, as noted above, an expanded cellular polymeric material which may therefore be an expansive or expanded foam.

The use of an expansive polymeric material, its expansion reaction taking place during densification of the woven preform by means of resin, can lead to high porosity rates (gas bubbles in the material due to the release of gases produced by the expansion reaction of the foam) which negatively impact the mechanical properties of the part.

The use of such an expansive material instead of a solid foam with finished dimensions can lead to irregularities in the shape of the internal cavity of the part. Although these shape irregularities are less detrimental than deviations in the external surface (within the aerodynamic flow), they must nevertheless remain under control.

All this therefore poses problems that the present solution seeks to take into account.

The weaving of the part (blank or preform) may be in three dimensions, which will facilitate obtaining a high-performance industrial part, such as a blade. To best ensure industrially the aforementioned function of “flexible membrane” (if adopted), it is proposed to use:
an inflatable bladder, which will be inflated in the cavity, or
a preformed part (reusable or not reusable) made of silicone or polyurethane elastomer.

Thus, the advantage of an adapted deformation of the flexible membrane, necessary for its installation in the cavity or even its removal, will be combined with a mechanical resistance suitable for the injection pressure and for preserving the required volume of the cavity.

To facilitate reinforcing the woven composite part, while doing this at a favorable moment in terms of ease of implementation in the method, it is also proposed that the method defined here further comprises, between the weaving of the part integrating the cavity and the step where the expansive paste is contained in the cavity:
weaving an insert (therefore able to be three-dimensional), which may be adapted to define a stiffener (also defined as a possible spar hereinafter), for the part having the cavity,
inserting the woven insert into the cavity of the part.

This solution, however, requires the woven insert to be manufactured independently from the manufacturing of said part with integrated cavity.

To avoid this and create an insert in this cavity by a local modification of the weave, it is also proposed that the weaving of the part comprises co-weaving with a woven insert (therefore able to be three-dimensional) which will therefore be integrated into said part. In other words, the weaving of the part (integrating the cavity) will comprise co-weaving with a woven insert (therefore able to be three-dimensional) which said part then integrates so as to be a single part.

Generally speaking, and depending on the type of core (soluble or removable) chosen for forming the cavity, the geometry of the cavity, and the need for stiffeners or spars, it will be possible to densify them at the same time as preforming the part to be produced, instead of producing these sub-components during separate prior injections.

Typically, all the woven textiles may comprise an interlacing of threads divided into two categories: “warp threads”, which are threads parallel to the selvages of the fabric, and “weft threads” which are threads perpendicular to the warp threads and intertwined with them in a pattern called a “weave”, the simplest weave consisting of an alternation in which each weft thread passes successively above and below a warp thread, with an offset from one weft to the other (solution called “plain weave”).

Furthermore, providing that the weaving of the part incorporating the cavity comprises a decoupling, will facilitate the formation of the cavity, or housing, inside the fibrous structure that is to form said woven composite part.

For the placement of the expansive paste in the cavity, two possibilities are available:
either introducing the paste directly into the cavity, in contact with the wall that delimits the cavity,
or placing a (or another) flexible membrane or hollow flexible bladder in the cavity, the expansive paste being contained (after having been introduced therein) in this (other) flexible membrane or flexible bladder, said (other) flexible membrane or flexible bladder forming an interface between the composite part and the paste, then the expanded foam, and being held in place in the mold permanently. This can facilitate the handling of the expansive paste and can reduce the risk of leaks.

In addition to the simplicity of the implementation and the possibility of production on a large scale, the advantages of the various aspects of the method just presented are those of the part itself, also already presented.

For the advantages already mentioned, the following are proposed as embodiments that may optionally be implemented, independently or in combination, in whole or in part, depending on the case:
the placement of the expansive paste comprises introducing it at the bottom of the cavity, so that the expansive paste expands from the bottom towards the at least one opening,
the expansive paste is placed in the cavity, after selecting as the expansive paste an expandable polymer from which gases are released during a polyaddition reaction to form said cellular material, which will then be dense in the cavity (well-controlled process and reproducible in series),
polyurethane is selected as the expandable polymer from which the release of CO2 during the polyaddition reaction forms said dense cellular material (well-controlled process reproducible in series, and an initial paste which is not difficult to procure).

“Dense” means uniformly and completely filling the cavity while having a sufficiently high density to ensure good mechanical performance of the foam in relation to its functions detailed above. This density nevertheless remains significantly lower than the other component materials of the blade assembly, and is preferably greater than 50 kg/m³ , or even between 100 kg/m³ and 300 kg/m³.

As will have been understood, the method presented above, with all or part of its features, will allow manufacturing a part, in particular a blade preform, for an aeronautical turbine engine.

### BRIEF DESCRIPTION OF DRAWINGS

Other features, details and advantages of the invention will become apparent upon reading the detailed description below of some non-limiting exemplary embodiments, and upon analysis of the appended drawings, in which:

FIG. 1 is a schematic view of a blade in accordance with one embodiment of the invention,

FIG. 2 is a cross-section of the blade of FIG. 1 in section plane A of FIG. 1;

FIG. 3 is a cross-section of the blade of FIG. 1 in section plane B of FIG. 1;

FIG. 4 is a cross-section of the blade of FIG. 1 in section plane C of FIG. 1;

FIG. 5 is a longitudinal section view of the blade of FIG. 1 in section plane D of FIG. 1;

FIG. 6 is a longitudinal section view of the blade of FIG. 1 in section plane E of FIG. 1;

FIG. 7 is a longitudinal section view of the blade of FIG. 1 in section plane F of FIG. 1;

FIG. 8 is a schematic perspective view of the fibrous structure blank after cutting the external loose threads;

FIG. 9 is a schematic perspective view of the fibrous structure blank after cutting the loose threads present on the spar portion of the preform;

FIG. 10 is a schematic perspective view of the fibrous structure obtained, as well as a view of its shaping with shaping parts;

FIG. 11 schematically illustrates a variant of the blade of FIG. 1, in a state where the part is still only fibrous, in the preform state;

FIG. 12 is a cross-section of the blade of FIG. 11, in section plane H;

FIG. 13,

[symbol]

FIG. 14,

[symbol]

FIG. 15,

[symbol]

FIG. 16, and

[symbol]

FIG. 17 schematize successive steps in the manufacturing of a hollow fibrous part in an injection mold, these steps consisting of a densification which may be a densitifcation of the preform of FIG. 11,

FIG. 18 schematically illustrates, in the same section view, the state of the part of FIG. 11 after said densification and after supplying an expansive foam into the cavity preserved in said hollow part;

FIG. 19 schematically illustrates, in the same section view, a preparatory state for the supplying of said expansive foam into the cavity, according to one variant,

FIG. 20 schematically illustrates, again using the same section view, the state of the part in FIG. 19 after adding the expansive foam to the bladder placed in the cavity in the step of FIG. 19.

### Description of Embodiments

The drawings and the description below contain elements that may not only serve to providing a better understanding of the present invention, but where appropriate may also contribute to its definition.

The invention applies in general to the production of various parts, in particular propeller blades or vanes used in aircraft engines. A blade according to the invention may in particular constitute a blade for a shrouded movable wheel such as a fan blade, or a blade for an unshrouded movable wheel as in the so-called “open rotor” aeronautical engines.

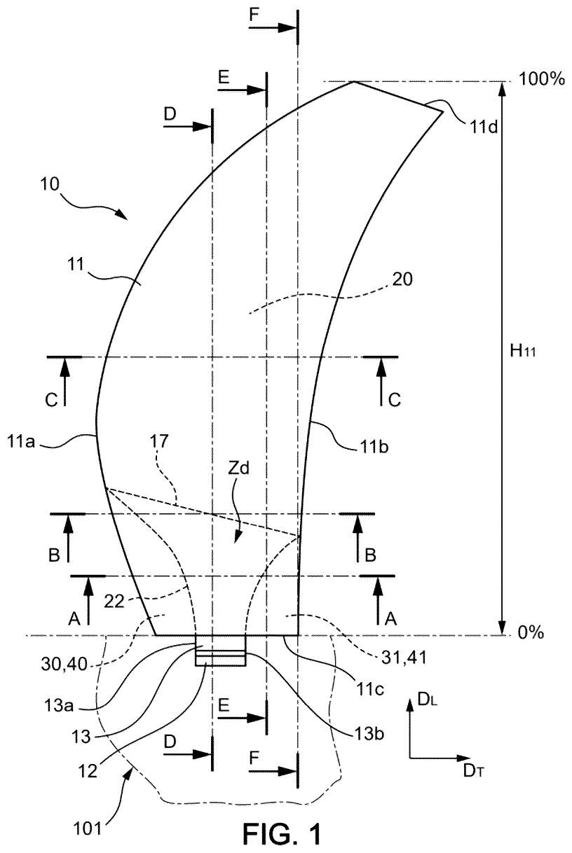

FIG. 1 represents a blade 10 intended to be fixed on an aeronautical turbine engine.

As with any aeronautical blade (or propeller blade) concerned here, blade 10 has a free edge or end 11d, and, at the opposite end, a root 12 by which the blade is fixed to a rotor disc 101 of the turbine engine.

More precisely, blade 10 comprises an airfoil 11 intended to form the aerodynamic portion of the blade and a root 12 formed by a portion of greater thickness, for example having a bulb-shaped cross-section. A shank 13 may be interposed between root 12 and airfoil 11. The cross-section of the airfoil 11 structure has a curved profile of variable thickness between its leading edge 11a and its trailing edge 11b in a direction DT that is transverse to longitudinal direction DL, or to the elongate direction, of the blade. Airfoil 11 extends in longitudinal direction DL between a root edge 11c (or edge for attachment to rotor disc 101) and a free edge (or tip edge) 11d. Root 12 extends in transverse direction DT for a length that is less than the length of root edge 11c of airfoil 11.

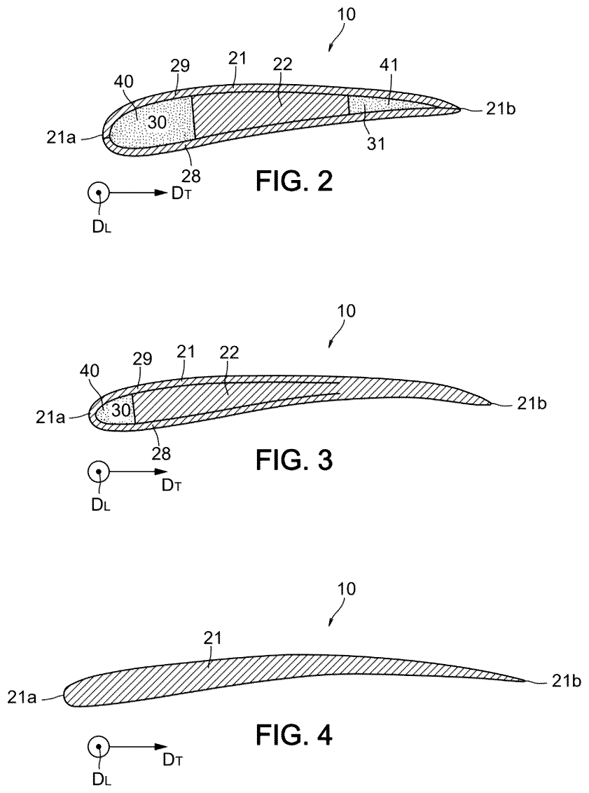

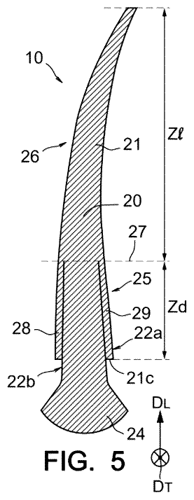

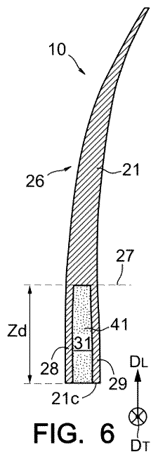

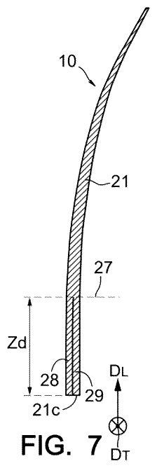

As shown in FIGS. 1 to 7, blade 10 comprises a fibrous reinforcement, referenced 20 in certain figures, and densified by a resin matrix. Fiber reinforcement 20 comprises, as a single piece:
an airfoil structure 21 intended to form the airfoil of blade 10,
a spar portion 22 extending inside airfoil structure 21,
a bulged portion 24 forming blade root 12, extending as an extension of spar portion 22 to outside airfoil structure 21.

Spar portion 22 may have, as a single piece:
a portion 22a extending inside airfoil structure 21, and
a portion 22b located outside airfoil structure 21 and forming both bulged portion 24 and, if it exists, shank 13 of blade 10.

Fiber reinforcement 20 mainly comprises first and second portions 25 and 26 which are separated from each other by an intermediate zone 27. First portion 25 delimits one or more decoupling zones Zd inside airfoil structure 21, the decoupling zone extending between intermediate zone 27 and root edge 21c of airfoil structure 21 corresponding to root edge 11c of airfoil 11 in longitudinal direction DL, and between front and rear edges 21a and 21b of airfoil structure 21 which respectively correspond to leading edge 11a and trailing edge 11b of airfoil 11 in transverse direction DT. First portion 25 comprises first and second skins 28 and 29 which are decoupled from each other and are decoupled from spar portion 22, said first and second skins 28 and 29 extending between front and rear edges 21a and 21b of airfoil structure 21 in the transverse direction and between intermediate zone 27 and root edge 21c of airfoil structure 21 in the longitudinal direction, said skins 28 and 29 clasping spar portion 22. First and second skins 28 and 29 delimit, inside airfoil structure 21, first and second housings 30 and 31 which are present one on either side of spar portion 22 in the transverse direction, the openings of first and second housings 30 and 31 being at root edge 21c of airfoil structure 21. A first shaping element 40 is present in first housing 30. Similarly, a second shaping element 41 is present in second housing 31.

Often, shaping elements such as 40,41 are referred to in the art as “cores”; see below.

The shaping elements such as 40,41, or cores, may typically each be formed from a solid block, typically a rigid foam element made by molding or by machining a block of material. It is possible to dissolve each core in the cavity or remove it (withdraw it from the cavity).

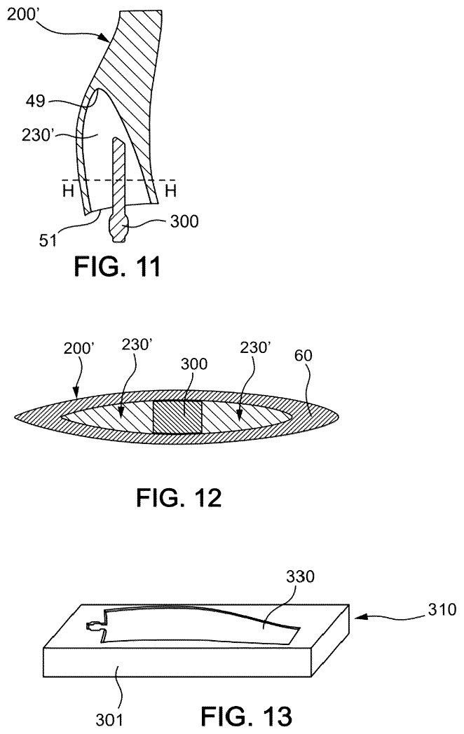

As an alternative to spar portion 22, an insert 300 (which can be defined as a reinforcement insert or stiffener) could extend inside an airfoil structure where it would then be temporarily surrounded by a shaping element or a pressurized membrane occupying the remaining volume of cavity 230′, around insert 300, according to one embodiment which would be for example in accordance with the schematic illustrations in FIGS. 11 to 17.

Portion 22a and bulged portion 24, or portion 22b, could be presented as such an insert, corresponding to insert 300.

In this solution:
blade 10 becomes blade or vane 10′,
fibrous reinforcement 20 made of 3D woven material remains; it simply changes its reference: 20′,
spar portion 22 is therefore replaced by at least one insert or stiffener, such as 300, woven in 3D and ultimately made of the same composite material (resin+fibers) as fibrous structure 200′ if it is not made of metal (which is possible), or may even be co-woven with it,
first and second housings 30, 31 may be retained, or replaced by a single housing defined below by cavity 230′ which extends inside airfoil 11′.

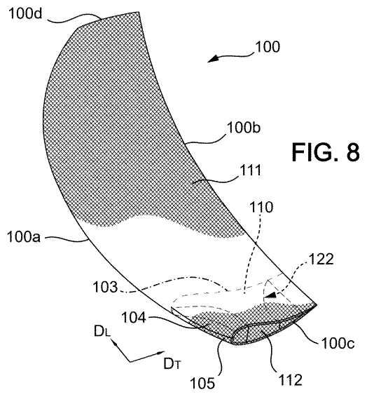

Applicable in particular in these two cases and as illustrated in the example of FIGS. 8 to 10, the method for manufacturing an aeronautical part according to the invention comprises the production of a fibrous structure, not yet impregnated with resin, such as the fibrous structure 100 intended to form the fibrous preform of the part to be produced.

The fibrous structure blank 100 is obtained by three-dimensional (3D) weaving carried out in a known manner using a loom which may be a jacquard type loom, on which a bundle of warp threads or strands has been arranged in a plurality of layers of several hundred threads each, the warp threads being bound in place by the weft threads. Fibrous structure blank 100 is woven as a single piece. The blank comprises, in this example, an airfoil blank 111, a spar portion blank 122, and a bulged portion blank 112, spar portion blank 122 extending inside fibrous structure blank 100 at a distance from front and rear edges 100a and 100b in transverse direction DT, and, in longitudinal direction DL, between an intermediate zone 103 located respectively between the root and free (or tip) portions 100c and 100d of the fibrous structure blank, bulged portion blank 112 extending as an extension of spar portion blank 122.

In the example illustrated, the 3D weave is an “interlock” weave. “Interlock” weave is understood here to mean a weave in which each layer of weft threads binds several layers of warp threads, with all the threads of a same weft column having the same movement in the plane of the weave.

Other known types of weaving, in particular three-dimensional, may be used, in particular such as those described in document WO 2006/136755. This document describes in particular the production, by weaving as a single piece, of the fiber reinforcement structures for parts such as blades having a first type of core weave and a second type of skin weave which make it possible to impart both the mechanical and aerodynamic properties that are expected for this type of part.

The fibrous blank according to the invention may be woven in particular from threads of carbon fiber or ceramic fiber such as silicon carbide.

As the fibrous blank is woven, of a thickness and width which may vary as in the example, a certain number of warp threads may therefore not be woven in, which makes it possible to define the desired contour and thickness, continuously variable, of blank 100.

Furthermore, during the weaving of the fibrous blank, a decoupling 110 may be carried out inside the fibrous blank between successive layers of warp threads, in one or more decoupling zones Zd.

In direction DL, a coupling zone ZI in the fibrous blank extends the one or more decoupling zones Zd, such that, if H11 is the length of airfoil 11, H11=Zl+Zd.

More precisely, in the example (see FIG. 8), the decoupling 110 extends between an intermediate zone 103 and root edge 100c of fibrous structure blank 100 in longitudinal direction DL, and between front and rear edges 100a and 100b of fibrous structure blank 100 in transverse direction DT. Decoupling 110 separates the first and second portions present one on either side of spar portion blank 122 so as to form first and second skin blanks 104 and 105 which are decoupled relative to each other. First and second skin blanks 104 and 105 extend between front and rear edges 100a and 100b of fibrous structure blank 100 in transverse direction DT, and between intermediate zone 103 and root edge 100c of the fibrous structure blank in the longitudinal direction. Skin blanks 104 and 105 clasp spar portion blank 122 and bulged portion blank 112. The first and second skin blanks delimit, inside fibrous structure blank 100, first and second housings 130 and 131 which are respectively present one on either side of spar portion blank 122 in transverse direction DT.

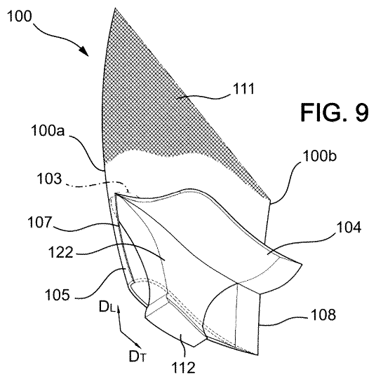

Once fibrous structure blank 100 has been woven, the loose threads present on the outside of the woven mass are cut, for example using a jet of water, so as to define the outer contour of a fibrous structure as illustrated in FIG. 8 by way of example. Loose threads present on skin blanks 104 and 105 are also cut at the lower part of the fibrous structure blank so as to release the bulged portion blank 112 as well as part of the spar portion blank 122 intended to subsequently form a blade shank. The loose threads present around spar portion blank 122 and bulged portion blank 112 are also cut by lifting skin blanks 104 and 105 as shown in FIG. 9, by way of example. For this purpose, first and second slits 107 and 108 are formed between skin blanks 104 and 105.

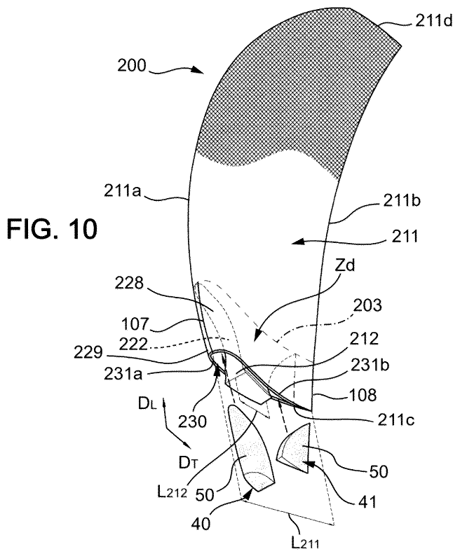

As illustrated in FIG. 10 by way of example, a fibrous structure 200 woven as a single piece is then obtained, in this example having an airfoil 211, a spar portion 222, and a bulged portion 212, airfoil 211 extending in longitudinal direction DL between a lower end 211c and an upper end 211d, and extending in transverse direction DT between a leading edge 211a and a trailing edge 211b. Fibrous structure 200 comprises one or more decoupling zones Zd extending between leading and trailing edges 211a and 211b of airfoil 211 in transverse direction DT, and extending between an intermediate portion 203 and root edge 211c of airfoil 211 in longitudinal direction DL. Spar portion 222 extends inside airfoil 211 at the one or more decoupling zones Zd, set back from leading and trailing edges 211a and 211b in transverse direction DT, and, in longitudinal direction DL, between an intermediate portion 203 located between lower and upper edges 211c and 211d of airfoil 211 and root edge 211c of said airfoil where the opening of spar portion 222 is located. Bulged portion 212 extends as an extension of spar portion 222, outside airfoil 211, bulged portion 212 extending in transverse direction DT for a length L212 that is less than length L211 of root edge 211c of the airfoil. Bulged portion 212 is intended for subsequently forming blade root 12. Airfoil 211 comprises, at the one or more decoupling zones Zd, first and second skins 228 and 229 which are decoupled relative to each other, the first and second skins extending between leading and trailing edges 211a and 211b of the airfoil in transverse direction DT and between intermediate portion 203 and root edge 211c of the airfoil in longitudinal direction DL, skins 228 and 229 clasping spar portion 222.

First and second skins 228 and 229 delimit, inside the airfoil, at least one cavity 230 which, in the example, is defined by first and second housings 231a and 231b which are respectively present one on either side of spar portion 222 in the transverse direction. Cavity 230, and therefore first and second housings 231a and 231b in the example, is/are open to the exterior. This opening is, in the example, located at the lower end of airfoil 211.

In an alternative associating an insert 300 which may therefore be made of metal, as in the example part in FIGS. 11, 12, it is therefore insert 300 which replaces bulged portion 212 and part 222.

Thus, in each situation where the weaving of a piece is carried out at the end of the manufacturing process, using composite material (resin +fibers), in particular as with woven fibrous structure blank 100 and woven fibrous structure 200, at the end of the process there will be a cavity 230 or 230′ integrated as a single part in the woven structure.

Furthermore, with these examples of a possible integrated spar extended by a root 12, or of a possible reinforcement insert 300 forming a stiffener or possible spar, it is possible to:
reinforce the woven part, at the location of its cavity 230 or 230′,
add or integrate a blade root 12, if necessary,
and doing so with an insert 300 which could be one piece with the woven fibrous structure, or added in its cavity, such as 230′ in the example.

In other words, insert 300:
either will have been manufactured separately (of a suitable material such as metal or woven in two or three dimensions) so as to define a stiffener, with or without a root 12, for the part having the cavity, such as 230′ in the example, then inserted into this cavity after the desired preform has been woven, 200′ in the example,
or will have been integrated as a single piece with said preform, the weaving of the part (200′ in the example) which integrates the cavity therefore comprising a co-weaving of such a stiffener; the insert denoted 300′ in FIG. 15 simulates and schematizes this hypothesis of a dry woven preform allowing the formation of a stiffener after resin is injected into the mold (see below).

In the second case, the co-weaving of the reinforcement insert, such as 300′, with the woven fibrous structure, may be carried out as with the fibrous structure blank 100; the same being true in the second case for the independent weaving of reinforcement insert 300, but without the cavity.

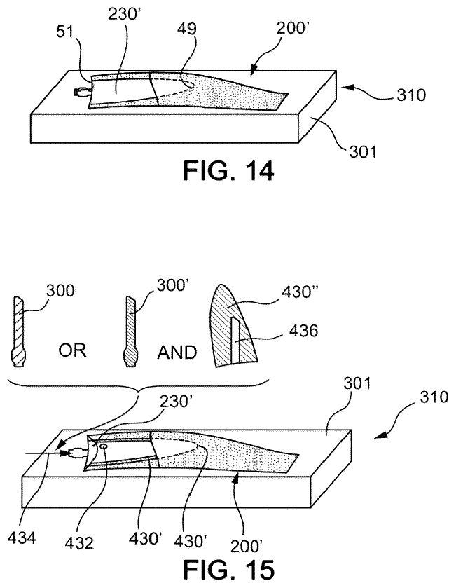

The shaping of fibrous structure 200 (which makes it possible to obtain the aforementioned blade preform, in the example) will then continue by:
introducing at least one shaping element into the or each aforementioned cavity,
and installing the part, namely woven fibrous structure 200 or 200′ in the example, in a first portion 301 of an injection mold 310 for the part concerned (see FIGS. 13, 14 for one example).

The impression mold portion for the part concerned, first portion 301 of injection mold 310, is denoted 330 in FIG. 13.

As an example, FIGS. 13 to 17 aim to help understand the portion of the method relating to molding the part by injecting resin 60 into the heart of the fibers of the fibrous structure, as in 200′ in the example.

Thus, the fibrous structure, such as 200′ in the example, is first placed in impression mold portion 330; see the example in FIG. 14.

It is then possible to insert into the cavity, such as 230′ in the example, the suitable core(s) and/or flexible membrane and/or insert(s) and/or stiffener(s) and/or possible spar(s) 300.

In FIG. 15, the presence of a composite or metal stiffener 300 manufactured beforehand is shown, or, alternatively, a dry woven preform allowing the formation of a stiffener after resin 60 is injected, this dry woven preform therefore possibly having been co-woven with the rest of the woven fibrous structure (denoted 300′).

Added to this is the insertion into the or into each aforementioned cavity, such as 230′ in the example, of at least one soluble core or removable core (see references 40, 41 in FIG. 10) or of a flexible membrane 430′ subjected to pressure in the cavity via an inlet 432 for pressurized gas, as is the case in the example in FIG. 15.

In the example of FIG. 15, we have also shown:
at the bottom of the figure, the case where cavity 230′ contains a removable inflatable membrane 430′ and,
at the top, an alternative in which, in cavity 230′, one would insert (arrow 434), around an insert or stiffener 300 or 300′, a solid core 430″ of the same nature as shaping elements 40, 41.

Core 430″ integrates a central volume 436 in the shape of (part of) the insert or stiffener 300 or 300′ located in cavity 230′ which may therefore be engaged therein.

Thus, in one way or another, the volume of the or of each aforementioned cavity, such as 230′ in the example, will then be occupied by a core or equivalent and will withstand the pressure of injecting the resin 60 which can now take place:
within the fibers of the fibrous structure, such as 200′ in the example, including the insert or the stiffener if it is a woven part, such as dry woven preform 300′,
but not in said cavity.

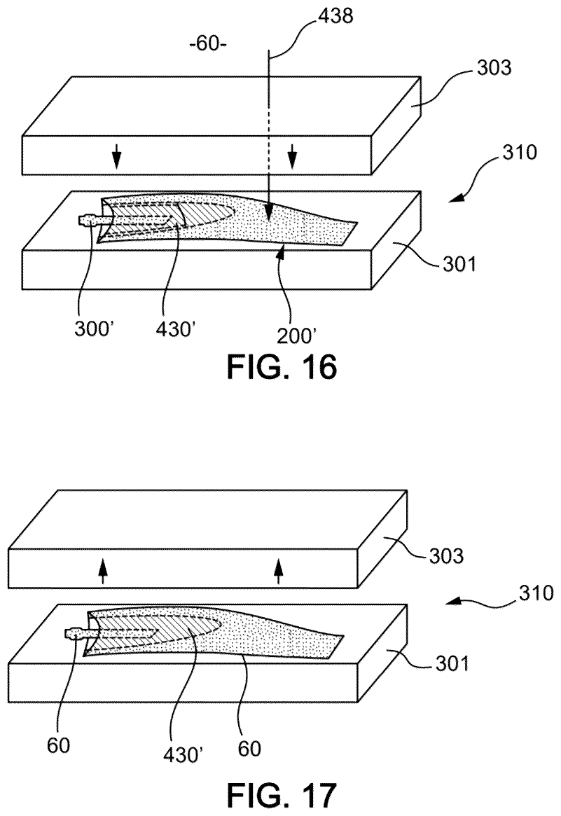

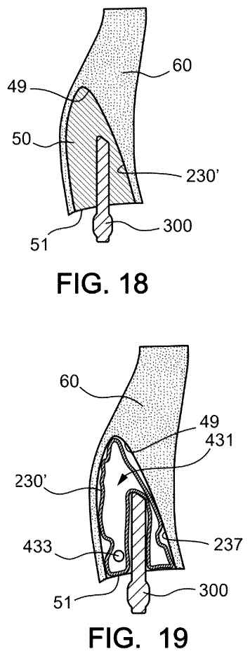

For this, another impression mold portion 303 of mold 310, with a suitable impression cavity, will close off the mold, as is schematically shown in FIG. 16, and resin 60 will be injected under pressure (this may be at room temperature) into the two impression mold portions (arrow 438) within the preform in order to densify it and form the composite material.

When the mold is reopened (as in the example of FIG. 17), resin 60 has infiltrated the two impression mold portions, but not the cavity, such as 230′ in the example, thus densifying the fibrous structure and forming the aforementioned composite material.

The obtained blank for the part may then be unmolded and deburred.

If cavity 230, 230′ contains at least one core 430″, the core is then dissolved if it is soluble, or removed if it is a removable core or a removable membrane 430′.

Since cavity 230, 230′ has become accessible, we will now be able to add the quantity of expansive paste 50 adapted to occupy the entire available volume.

We then wait for paste 50 to react to form a foam, the expanded paste being adapted to fill the cavity and to ensure that the shape of the final part obtained is maintained during operation.

Any excess foam overflowing from the cavity may then be removed, if any, and the part may then be checked for compliance (verifying the composite material, dimensional verifications) and the obtained composite part can be finalized.

The advantage of only adding expansive paste 50 after molding, and therefore after densification of the (of each) woven piece, is that it offers precise control over the geometry of the cavity, in addition to controlling the external geometry of the part.

As has already been mentioned, this thus reduces the risk:
of a high porosity rate (gas bubbles in the material due to the release of gases produced by the expansion reaction in the foam), negatively impacting the mechanical properties of the part, and
of irregularities in the shape of the internal cavity of the part.

Furthermore, such a solution where a cavity is filled with expanded foam has the advantage of reducing the cost of the part compared to a solid foam, because the soluble or removable core has a generally low cost per part.

Another advantage may be the guarantee that the release of gases that cause the expansion of the foam 50 will not contaminate the resin 60 used for densifying the composite, which could be the case with a chronology as follows: provide expansive paste 50—wait—close the mold—densification by injection of resin 60, said contamination possibly resulting in porosity (gas bubbles) in the matrix of the composite material, with the consequence being a reduction in the mechanical properties of the material.

The use of an expansive paste 50 instead of a solid foam, if the (a) cavity of the part must contain an insert 300, also makes it possible to more easily avoid the typical invitation—see above—to weave the first and second aforementioned 3D woven preforms separately, in order to avoid creating an assembly constraint.

By removing this constraint, it will then be easier to envisage the aforementioned possibility of co-weaving:
the (each) second preform (and therefore the possible stiffener(s) and/or spar(s)),
with the first preform, such as fibrous structure 100,
this being done always before the molding in mold 310 then the placement of the expansive/foaming paste 50.

The 3D weaving of the first preform, as well as the decoupling (zone Zd mentioned above) and a local adaptation of the weaving style, will then make it possible to form said cavity, such as 230 or 230′. It will thus be possible to create one or more spar(s) or stiffener(s) in this cavity by a local modification of the weaving style.

The expansive nature of cellular material 50 will allow naturally adapting to all geometries of the cavity in the densified part, by hugging the contours at the ends of the cavity as well as around the stiffener(s) and/or spar(s), if they exist.

Concerning the placement of expansive paste 50, it will be possible in particular to provide:
that the (each) cavity, such as 230 or 230′, has a bottom 49 and an opening 51, and
that this placement comprises introducing the expansive paste at the bottom 49 of the cavity, so that expansive paste 50 expands from bottom 49 towards opening 51, thus reducing the risk of excessive overflow to outside the cavity.

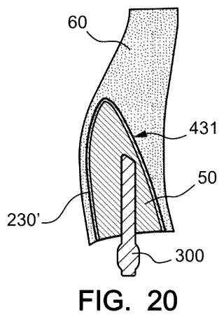

If expansive paste 50 can be used directly in contact with the fiber+resin composite, the use of a flexible membrane, such as a flexible (hollow) bladder such as 431 in the example of FIGS. 19, 20, filled with expansive paste 50 may optionally be considered.

Such a flexible membrane, hereinafter referred to as a “flexible bladder” so as not to confuse it with the possible membrane 430′, will in principle be thinner than membrane 430′, since injection of resin 60 has already taken place and therefore the integrity of the cavity is already ensured.

If it exists, the flexible bladder, such as 431, therefore has the purpose of containing expansive paste 50 and then the expanded cellular polymer resulting therefrom, thus facilitating implementation. But not using a bladder would have the advantage of a more direct contact between the cellular material, the fibers, and the resin of the composite material, if these are compatible. If they are only slightly compatible, it will be preferable to isolate the different components and therefore to retain the use of a flexible bladder.

The choice between these two options may also be dictated by the mechanical strength of the interface created between expanded cellular material 50 and said fiber/resin composite. It may be desired to ensure that the interface is indeed resistant to stress and has a good service life. A solution without a flexible bladder seems more favorable for this aspect, because it allows direct physicochemical contact between expanded cellular material 50 and the resin of the composite material.

With a flexible bladder, opening 51 must allow:
the insertion of flexible bladder 431 into said cavity;
then the addition of expansive paste 50 to bottom 49 of this cavity, in the bladder, so that expansive paste 50 grows by expanding from the bottom of the cavity towards its opening 51, without creating a vacuum pocket during its evolution into foam, while pressing the bladder against wall 237 of the cavity (see FIG. 20, for example).

As an alternative to a flexible bladder 431 that is open on the same side as opening 51, as in the example of FIG. 20, a closed bladder provided only with an inlet 433 could be provided, inlet 433 being adapted for the supplying of expansive paste 50 into the bladder (see FIG. 19, for example).

In any case, once in place in the cavity, the flexible bladder will remain there permanently.

Polyurethane, the well-known expandable polymer, may be used as the expansive material 50, as its release of CO2 during the polyaddition reaction forms a cellular material such as a dense foam, commonly used in industry.

In the case of the present invention, the parameters to be considered when selecting an expansive polymer for material 50, will favorably be:
the mechanical properties of material 50 after expansion (density, compressive strength, etc.), in order to guarantee the functionality of the invention;
the implementation parameters (expansion time, expansion temperature), so as not to complicate the assembly;
the specific characteristics of the polymer: compatibility with the materials of the bladder if necessary and of the rotor disc if it is a blade, etc.

Concerning the injection of resin 60 into closed mold 310, and therefore the densification of the fibrous preform concerned, if slits 107 and 108 are present on leading and trailing edges 211a and 211b, they will preferably be sewed shut before densification, such densification consisting of filling in the porosities of the preform, in all or part of the volume thereof, with the component material of the matrix.

The matrix of the composite material may be obtained in a manner known per se, according to the liquid process. The liquid process consists of impregnating the preform with a liquid composition containing an organic precursor of the matrix material. The organic precursor is usually in the form of a polymer, such as resin, as mentioned above (which the expression “organic precursor” can replace), possibly diluted in a solvent. Mold 310 in which the preform will be placed may be sealed closed, therefore internally defining a housing having the shape of the desired final molded part.

Once mold 310 is closed, the liquid matrix precursor (therefore for example a resin) can be injected into the entire housing to impregnate the entire fibrous portion of the preform.

The transformation of the precursor into organic matrix, namely its polymerization, is carried out, as is known (this may or may not be by heat treatment), after removal of the solvent if any and crosslinking the polymer, the preform still being kept in the mold. The organic matrix may be obtained in particular from epoxy resins, such as the high-performance epoxy resin sold by the company CYTEC under the reference PR 520, the one sold by 3M under the reference Resin “2896”, or from liquid precursors of carbon or ceramic matrices.

In the case of formation of a carbon or ceramic matrix, the heat treatment consists of pyrolyzing the organic precursor in order to transform the organic matrix into a carbon or ceramic matrix depending on the precursor used and the pyrolysis conditions. Several consecutive cycles, from impregnation to heat treatment, may be carried out in order to achieve the desired degree of densification.

If instead of a three-dimensional part, it is desired to obtain a two-dimensional (2D) part, this will be possible in particular if the 2D fabric is draped over each of the mold portions or if, for a blade, the suction side of the blade is draped over expansive paste 50, and the mold is closed afterwards. Thus, if 2D weaving is planned, it is proposed to weave the suction side portion separately from the pressure side portion and to produce them either by co-firing (with a resin interface between the two portions) or by sewing before shaping.

Furthermore, the densification of the fibrous preform may be carried out by the well-known process of resin transfer molding, therefore referred to as RTM, in which a thermosetting resin is injected into the available internal space of the mold. A pressure gradient is generally established in this internal space between the location where the resin is injected and the orifices for discharging the resin, in order to control and optimize the impregnation of the preform by the resin.

Concerning the placement of any insert, such as 300, in the cavity that is to receive it, any retaining means necessary for suitably positioning the insert in the cavity (centering arm, etc.) will be used when necessary.

1. A three-dimensional part comprising:
a composite material including a fabric and a resin, the part having at least one cavity (230, 230′) filled with a cellular material (50), each cavity having a bottom (49) and at least one opening (51),
wherein the fabric is formed by three-dimensional weaving and the cellular material comprises an expanded cellular polymeric material.

2. The part according to claim 1, wherein the cavity is delimited by the composite material.

3. The part according to claim 1, further comprising at least one insert adapted to define at least one stiffener.

4. The part according to claim 3, wherein the insert is arranged in one of the at least one cavities of the part.

5. A method for manufacturing a composite part, the method having steps of:
weaving the part, while integrating therein at least one cavity (230,230′) having a bottom (49) and at least one opening (51),
placing the part in a first portion (301) of an injection mold (310),
placing a soluble core, a removable demoldable core (40,41,430″) or a flexible membrane (430′) in the cavity (230,230′), which occupies the volume of the cavity,
closing the injection mold, by means of at least a second portion (303) of the injection mold,
injecting resin (60) into the weave, in order to form a woven part made of composite material,
demolding the part from the injection mold,
depending on the case, dissolving the soluble core, er removing the removable core or flexible membrane from the cavity,
placing in the cavity an expansive paste (50) adapted to form a cellular material,
waiting for the paste to react to form said cellular material in the cavity,
removing any excess cellular material that has overflowed from the cavity.

6. The method according to claim 5, wherein the weaving comprises weaving the part in three dimensions.

7. The method according to claim 5, wherein an inflatable bladder which is inflated in the cavity, or a preformed part made of silicone or polyurethane elastomer, is used as the flexible membrane.

8. The method of claim 5, further comprising, between the weaving of the part integrating the cavity (230,230′) and the step where the expansive paste is contained in the cavity:
weaving an insert (300′) for the part having the cavity,
inserting the woven insert into the cavity (230,230′) of the part.

9. The method according to claim 5, wherein the weaving of the part integrating the cavity comprises co-weaving with a woven insert (22) which said part then integrates so as to be a single part.

10. The method according to claim 5, wherein the weaving of the part integrating the cavity comprises a decoupling (110) carried out inside the part.

11. The method according to claim 5, wherein the placement of the expansive paste (50) comprises introducing it at the bottom of the cavity (230, 230′) so that the expansive paste expands from the bottom towards the at least one opening.

12. The method according to claim 5, wherein the placement of the expansive paste (50) in the cavity (230, 230′) comprises a prior selection of an expandable polymer from which gases released during a polyaddition reaction forms said cellular material, which is dense in the cavity

13. The method according to claim 12, wherein the selection of the expandable polymer comprises selecting polyurethane, from which the release of CO2 during the polyaddition reaction forms said dense cellular material (50).

14. The method according to claim 5, wherein the cellular material comprises an expanded cellular polymeric material.

15. The method according to claim 5, wherein, for the placement of the expansive paste in the cavity:
either the paste (50) is introduced directly into the cavity, in contact with the-a wall (237) that delimits the cavity,
or another flexible membrane or flexible bladder (431) is placed in the cavity, the expansive paste being introduced into this other flexible membrane or flexible bladder, said flexible membrane or flexible bladder (431) thus forming an interface between the composite part and the paste (50), then the expanded foam, and being held in place in the cavity (230,230′) permanently.
